(19) United States
(12) Patent Application Publication
(10) Pub. No.: US 2009/0294739 A1
(43) Pub. Date: Dec. 3, 2009

(54) CONDUCTIVE PASTE INCLUDING A CARBON NANOTUBE AND PRINTED CIRCUIT BOARD USING THE SAME

(75) Inventors: Eung-Suek Lee, Ansan-si (KR); Je-Gwang Yoo, Yongin-si (KR); Chang-Sup Ryu, Yongin-si (KR); Jun-Oh Hwang, Busan (KR); Tae-Eun Chang, Suwon-si (KR); Jee-Soo Mok, Yongin-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/263,685

(22) Filed: Nov. 3, 2008

(30) Foreign Application Priority Data
May 30, 2008 (KR) 10-2008-0051231

(51) Int. Cl. H01B 1/02

(52) U.S. Cl. 252/513; 252/512; 252/514

(57) ABSTRACT

The invention provides a conductive paste including a carbon nanotube and a printed circuit board using the same. The invention provides the conductive paste which exhibits an excellent electrical conductivity and allows the implementation of the X-Y interconnection and simultaneously the Z-interconnection without loosing the carbon nanotube's own original characteristics.

### CROSS-REFERENCE TO RELATED APPLICATIONS

This application claims the benefit of Korean Patent Application No. 10-2008-0051231 filed with the Korean Intellectual Property Office on May 30, 2008, the disclosure of which is incorporated herein by reference in its entirety.

### BACKGROUND

1. Technical Field

The present invention relates to a conductive paste including a carbon nanotube and a printed circuit board using the same.

2. Description of the Related Art

Copper (Cu) has been used for an electrical connection between an electric device and a component and between upper and lower layers considering specific resistance and economical view. According to the result obtained by experiments, when the cross sectional area of an implemented circuit line space is smaller than a mean free path (MFP) of an electron in a bulk metal, it is known that the specific resistance in the circuit increases much more significantly than the specific resistance which a metal itself has.

The MFP of copper is 40 nm. Therefore, when a circuit having a smaller cross sectional area than this value is implemented, copper's original specific resistance characteristics are not expected. According to literature, this happening is due to electron surface scattering and grain-boundary scattering. That is, since a metal conductive paste such as copper cannot be easily applied to fine circuits, demand for manufacturing a paste to replace the metal conductive paste increases.

A diameter of a carbon nanotube is generally several tens of nm so that it can be a great advantage to be applied for ultra fine wirings. The maximum allowable current of the carbon nanotube is about 1000 times better than that of copper (10⁶A/cm², CNT: 10¹⁰ A/cm²). Thus, extensive researches on using carbon nanotubes on the interconnection of signal wirings (X-Y interconnection) of a circuit board and of upper and lower copper clad signal layers (Z-interconnection) of a circuit board, instead of a metal such as copper.

To implement the X-Y interconnection, the carbon nanotube is artificially forced to form patterns by employing the tip of an atomic force microscopy. However the original characteristics (flexibility or elasticity, etc.) of the carbon nanotube are lost during the bending process of the carbon nanotube. Thus, there is no further progress on the implementation of the X-Y interconnection.

The research only on the Z-interconnection connecting the upper and lower copper clad signal layers of a circuit board is relatively actively under way. The carbon nanotube has to grow in a certain height for the Z-interconnection and this growth is mostly obtained by the chemical vapor deposition method.

However, when the chemical vapor deposition method is used, it creates a few drawbacks such as i) processing at a high temperature of 500-800° C., ii) limitation on materials to be used as a substrate due to high temperature processing, iii) time for mass production of electronic products due to batch process, which means increase in lead time, iv) limitation on operation size since the process has to be conducted in a vacuum chamber, and v) high manufacturing cost.

### SUMMARY

The present invention is to provide a conductive paste which has an excellent electrical conductivity without loosing their own original characteristics of carbon nanotubes and implements X-Y interconnection and simultaneously Z-interconnection, and a printed circuit board by employing the same.

According to an aspect of the invention, the invention provides a conductive paste including a carbon nanotube, a metal alloy having a low melting temperature and a binder.

According to an embodiment of the invention, the conductive paste may include 70-90 wt % of a carbon nanotube, 1-25 wt % of a metal alloy having a low melting temperature, and 1-15 wt % of a binder

The conductive paste may further include metal particles and the metal particles may be added in 1-10 wt %.

The metal particles may be chosen from silver, copper, tin, indium, nickel and a mixture thereof.

The carbon nanotube may be chosen from a single-walled nanotube, a multi-walled nanotube and a mixture thereof.

The metal alloy having a low melting temperature may be at least two chosen from tin, bismuth, indium, sliver and cadmium.

The metal alloy having a low melting temperature may be an alloy chosen from tin/bismuth, bismuth/tin/cadmium, indium/tin and indium/tin/bismuth.

The tin/bismuth alloy may have 40-45 wt % of tin and 60-55 wt % of bismuth; the bismuth/tin/cadmium alloy has 45-50 wt % of bismuth, 15-40 wt % of tin, and 15-40 wt % of cadmium; the indium/tin alloy has 50-70 wt % of indium and 50-30 wt % of tin; and the indium/tin/bismuth alloy has 5-30 wt % of indium, 30-60 wt % of tin and 25-45 wt % of bismuth.

The binder may be chosen from a thermosetting resin, a thermoplastic resin, a UV hardening resin, a radical hardening resin and a mixture thereof.

The thermosetting resin may be chosen from an epoxy resin, a cyanate ester resin, a bismaleimide resin, a polyimide resin, a benzocyclobutene resin, a phenol resin and a mixture thereof.

The thermoplastic resin may be chosen from a liquid crystal polyester resin, a polyurethane resin, a polyamidimide resin and a mixture thereof.

The conductive paste may further include a dye, a pigment, a thickening agent, a lubricant, an antifoaming agent, a dispersant, a labeling agent, a brightening agent, a thixotropic agent, a retardant, a pickling agent, an organic filler, an inorganic filler, and a mixture thereof.

According to another aspect of the invention, the invention provides a printed circuit board including the conductive paste described above.

Additional aspects and advantages of the present invention will be set forth in part in the description which follows, and in part will be obvious from the description, or may be learned by practice of the invention.

### BRIEF DESCRIPTION OF THE DRAWINGS

FIGS. 1 to 3 are drawings illustrating an operation process of the conductive paste according to an embodiment of the invention.

FIG. 4 is a flow chart illustrating a method of manufacturing a printed circuit board according to an embodiment of the invention.

FIGS. 5 to 12 are flow diagrams illustrating a method of manufacturing a printed circuit board according to an embodiment of the invention.

FIGS. 13 to 16 are graphs illustrating the reliability against thermal cycle (TC), high accelerated temperature/humidity test (HAST), liquid-liquid thermal shock (LLTS) and solder spot of Example 1.

FIG. 17 illustrates X-Y interconnection and Z-interconnection.

### THE DESCRIPTION OF THE DENOTATION ABOUT THE MAIN PART OF DRAWING

| | |
|---|---|
| 11: | Copper clay layer |
| 12: | Carbon nanotube |
| 13: | Metal alloy having a low melting temperature |
| 14: | Binder |
| 21: | Copper clad laminate |
| 22, 26: | Etching resist film |
| 23: | Insulating layer |
| 24: | Coating layer |
| 25: | Via hole |
| 27: | Paste including a carbon nanotube according the invention |
| 28: | Via including a carbon nanotube paste according the invention |

### DETAILED DESCRIPTION

The conductive paste including a carbon nanotube and a metal alloy having a low melting temperature of the invention exhibits an excellent electrical conductivity due to reduced specific resistance. Further, the conductive paste of the invention allows implementation of the X-Y interconnection and simultaneously the Z-interconnection without loosing the carbon nanotube's own original characteristics.

The carbon nanotube exhibits superior electrical properties compared to other materials as shown in the following Table 1.

TABLE 1

| Physical | | | | |
|---|---|---|---|---|
| properties | carbon nanotube | | Compared materials | |
| density | 1.33-1.40 | g/cm³ | 2.7 | g/cm³ (aluminum) |
| Current | 1 × 10⁹ | A/cm² | 1 × 10⁶ | A/cm² (copper cable) |
| density | | | | |
| Thermal | 6000 | W/mk | 400 | W/mk (copper) |
| conductivity | | | | |
| Specific | 1 × 10⁻¹⁰ | Ω · cm | 1.72 × 10⁻⁶ | Ω · cm (copper) |
| resistance | | | | |

As shown in Table 1, the carbon nanotube has better electrical properties than aluminum and copper which have relatively good electrical conductivity and specific resistance. When this carbon nanotube is used as a material for conductive pastes, it may allow lowering the resistance generated during electrical passes between layers of circuit patterns. Further, it may allow releasing heat inside a printed circuit board efficiently to outside.

The carbon nanotube and a metal alloy having a low melting temperature (LMPA) are used in the invention to prepare a conductive paste. Here, the melting property of the metal alloy having a low melting temperature may be able to bond a metal component having a low melting temperature with the carbon nanotube. Further, it allows bonding the metal alloy having a low melting temperature, the carbon nanotube and metal copper clad layers of a board. Such bondings reduce the specific resistance and improve the electrical conductivity of the conductive paste of the invention.

There have been some drawbacks such as specific resistance and electrical resistance of a paste with the hole plugging process. To resolve such problems is a method used to conduct electroless plating or electro plating to form an electrically conductive metal layer and fill a paste.

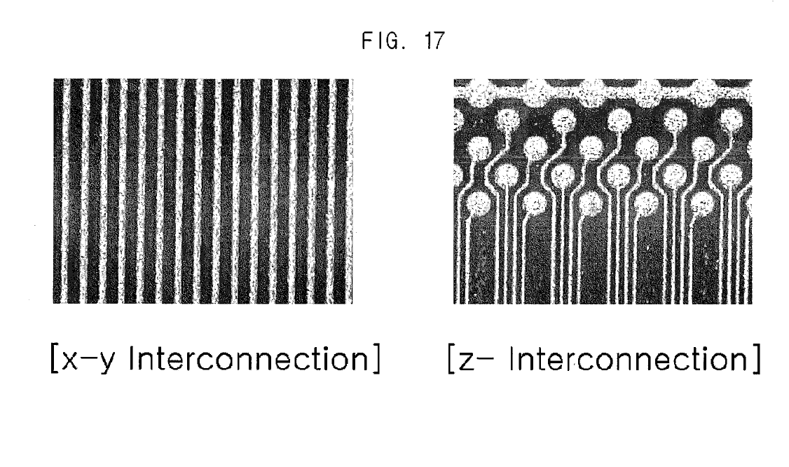

Since the conductive paste of the invention includes a carbon nanotube and a metal alloy having a low melting temperature, it expects a metal reaction between the metal particles and the carbon nanotube so that it may eliminate such mentioned problems. Further, the conductive paste of the invention may still remain its own original characteristics of the carbon nanotube at a low temperature of 200° C. or lower so that it allows implementing X-Y interconnection and simultaneously Z-interconnection. The X-Y and Z-interconnection is generally the interconnection shown in FIG. 17.

The conductive paste of the invention may include a carbon nanotube, a metal alloy having a low melting temperature and a binder.

The conductive paste according to an embodiment of the invention may include 70-90 wt % of a carbon nanotube, 1-25 wt % of a metal alloy having a low melting temperature, and 1-15 wt % of a binder. When the amount of the carbon nanotube is deviated from the above range, the carbon nanotube may not provide an electrical conductivity due to the percolation theory. When the metal alloy having a low melting temperature is used less than 1 wt %, a metal to be interred may not be sufficient to form an inter metallic compound. On the other hand, when it is used more than 25 wt %, it may cause oxidation problem associated with tin. When the binder is used less than 1 wt %, it may deteriorate the adhesiveness while when it is used more than 15 wt %, it may deteriorate the electrical conductivity.

The conductive paste may further include metal particles, preferably 1-10 wt %. When the metal particles are used less than 1 wt % or more than 10 wt %, it may not provide electrical characteristics due to the percolation theory.

The metal particles may be chosen from silver, copper, tin, indium, nickel and a mixture thereof but it is not limited thereto. The metal particles may have an oxygen content of 0.1 to 3 wt %, preferably 0.2 to 2.5 wt %, more preferably 0.3 to 2 wt %. When the metal particle has an oxygen content within this range, it may prevent ion migration and provide conductivity, electrical connection reliability and dispersity as a binder.

According to an embodiment of the invention, the carbon nanotube may be a single-walled nanotube, a multi-walled nanotube or a mixture thereof.

The metal alloy having a low melting temperature used in the invention may be an alloy composition having a melting temperature of 200° C. or lower. Since the melting temperature of the metal alloy having a low melting temperature is low, it may be melted prior to the binder so that it may be able to contact with the carbon nanotube and the copper clad layer of a board.

That is, the metal alloy having a low melting temperature of the invention may reduce contact resistance between the carbon nanotubes and introduce a metallic bonding with the copper clad layer of a board so that it may allow reducing the contact resistance of the board. The melting property of the metal particles having a low melting temperature is thus able for metallic bonding of metal components, resulting in reduction of the specific resistance.

According to an embodiment of the invention, the metal alloy having a low melting temperature may be at least two chosen from tin (Sn), bismuth (Bi), indium (In), silver (Ag), and cadmium (Ca) but is not limited thereto.

Particularly, the metal alloy having a low melting temperature of the invention may be one chosen from tin/bismuth, bismuth/tin/cadmium, indium/tin and indium/tin/bismuth but is not limited thereto.

Particularly, the tin/bismuth alloy has 40-45 wt % of tin and 60-55 wt % of bismuth; the bismuth/tin/cadmium alloy has 40-45 wt % of bismuth, 15-40 wt % of tin, and 15-40 wt % of cadmium; the indium/tin alloy has 50-70 wt % of indium and 50-30 wt % of tin; and the indium/tin/bismuth alloy has 5-30 wt % of indium, 30-60 wt % of tin and 25-45 wt % of bismuth.

More particularly, examples of the metal alloy having a low melting temperature may include 42Sn/58Bi (number is wt %, melting temperature (MP)=141° C.), 53Bi/26Sn/21Cd (MP=103° C.), 70In/3OSn (MP=126° C.), and 50In/5OSn (MP=117° C.), 10In/53Sn/37Bi (MP=100-123° C.).

The metal alloy having a low melting temperature may be any known commercially available product. Examples of the product may be metal products having a low melting temperature manufactured by MCP Group, Lowden Metals Ltd., RotoMetals Inc., Mitsui Mining Co., Ltd, Senju Metal Industry Co., Ltd., Duksan Hi-Metal Co., Ltd.

According to an embodiment of the invention, the binder may be one chosen from a thermosetting resin, a thermoplastic resin, a UV hardening resin, a radical hardening resin and a mixture thereof but is not limited thereto.

The thermosetting resin may be chosen from an epoxy resin, a cyanate ester resin, a bismaleimide resin, a polyimide resin, a benzocyclobutene resin, a phenol resin and a mixture thereof but is not limited thereto. The epoxy resin is more preferable in the invention.

The thermoplastic resin may be chosen from a liquid crystal polyester resin, a polyurethane resin, a polyamidimide resin and a mixture thereof but is not limited thereto.

The conductive paste of the invention may further include an additive chosen from a dye, a pigment, a thickening agent, a lubricant, an antifoaming agent, a dispersant, a labeling agent, a brightening agent, a thixotropic agent, a retardant, a pickling agent, an organic filler, an inorganic filler, and a mixture thereof. An amount of the additive may vary with desired purpose and use. The amount may be 1-7 wt % but is not limited thereto.

The pickling agent may remove oxidized materials on the surface of the metal alloy having a low melting temperature when tin is oxidized. Examples of the pickling agent may be a rosin flux, an organic flux and a surface treatment agent, etc. Such pickling agents are commercially available. Carbonic acids such as adipic acid and steraric acid, etc. and vinyl ethers may be used as the pickling agent.

When the inorganic filler is used, the thermal expansion coefficient of the conductive paste of the invention may be lowered. Examples of the inorganic filler may include silica in a flat shape, an amorphous shape and the like, alumina, talc, diatomaceous earth, nano filler and the like.

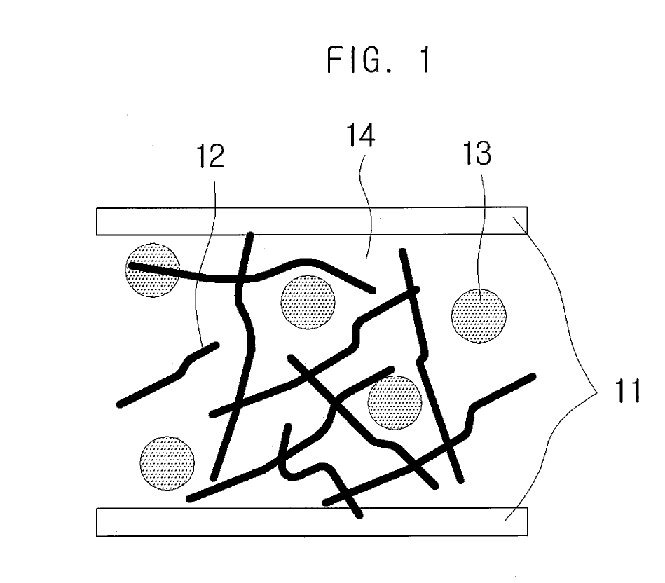

FIGS. 1 to 3 are drawings illustrating an operation process of the conductive paste according to an embodiment of the invention. FIG. 1 shows the conductive paste of the invention filled between copper foil layers. This is processed for a printing process at a particular temperature corresponding to a melting temperature of a metal alloy having a low melting temperature, for example 150-250° C. and a hardening process of pre-drying and drying in order.

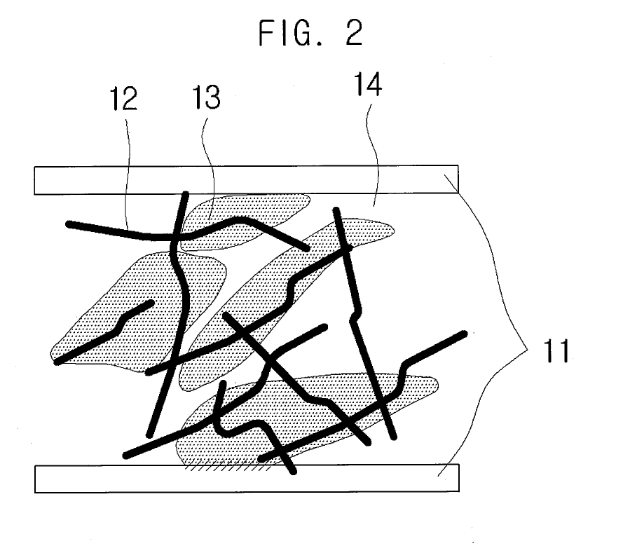

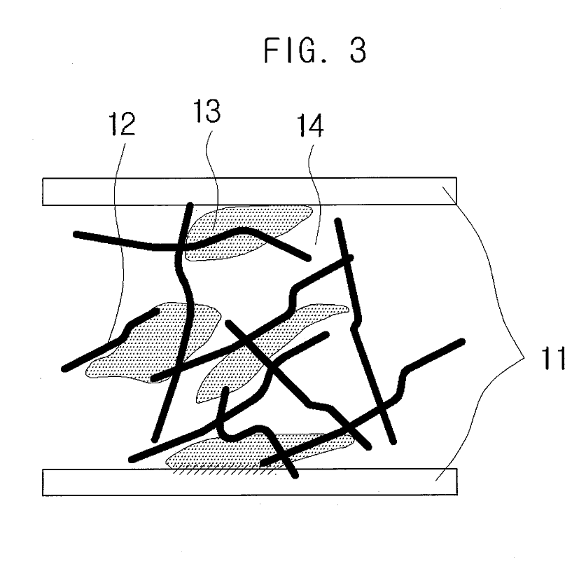

FIG. 1 shows the pre-drying process. Cross-linkings of a binder 14 may start under the pre-drying condition (80-100° C.) so that it allows inter-contact between metal alloy particles having a low melting temperature 13 and the copper clad layer 11. As shown in FIG. 2, a metallic bonding between the carbon nanotube 12 and the copper clad layer 11 is formed while the metal alloy particles having a low melting temperature 13 melts under the drying condition (100-168° C.) where the melting temperature of the metal alloy particles having a low melting temperature 13 is included. The binder is in the semi-hardened stage (B-stage). As shown in FIG. 3, the binder 14 is completely hardened through a laminating process (C-stage).

Particularly, when alloy particles including tin (Sn) as a main element among metal alloys having a low melting temperature is used, it may resolve an insulating distance inferiority for eutectic characteristics of tin while the conductive paste is laminated. Further, an interlayer registration of the upper and lower copper clad layers is well obtained due to the eutectic characteristics of tin.

As shown in FIGS. 1 to 3, the conductive paste of the invention allows the metallic bonding between metal components due to the melting property of metal alloy particles having a low melting temperature and further, the metallic bonding between the copper clad layer and the metal particles. Such metallic bondings reduce specific resistance and contact resistance. Therefore, the conductive paste of the invention eliminates problems including increased specific resistance due to a binder associated with the conventional conductive paste.

The conductive paste of the invention further allows X-Y interconnection and simultaneously Z-interconnection through the printing process since the surface, where the carbon nanotube contacts, and the carbon nanotube are able for the metallic reaction.

In addition, the paste of the invention eliminates several problems generated when the carbon nanotube grows by employing the chemical vapor deposition method at a high temperature since it uses the carbon nanotube at a temperature of 150-200° C.

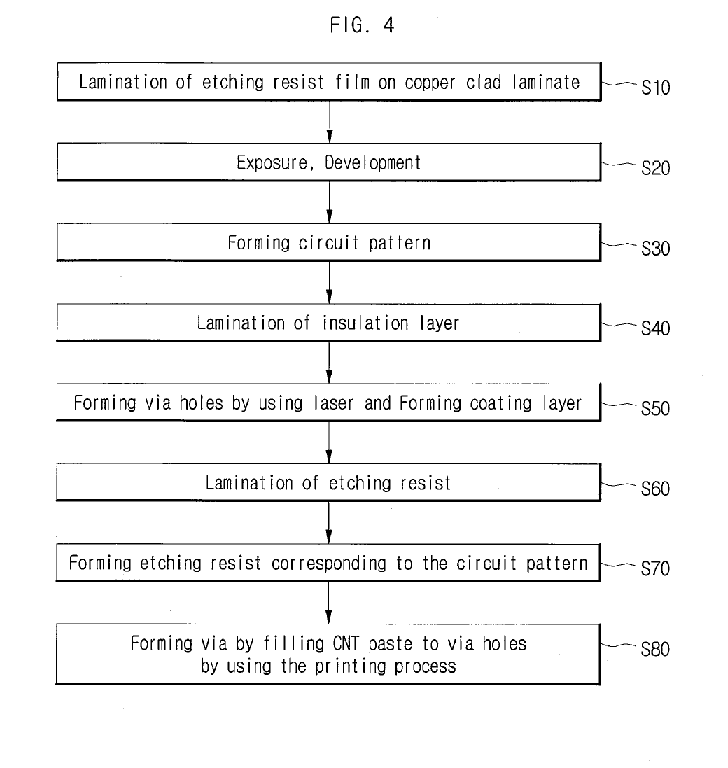

According to another aspect of the invention, the invention provides a printed circuit board using the conductive paste described above. Particularly, FIGS. 4 to 12 illustrate a method for manufacturing a printed circuit board according to an embodiment of the invention. The manufacturing method illustrated in Figures is only for explanation and thus the conductive paste of the invention may be applied to manufacture other printed circuit boards expect one in Figures.

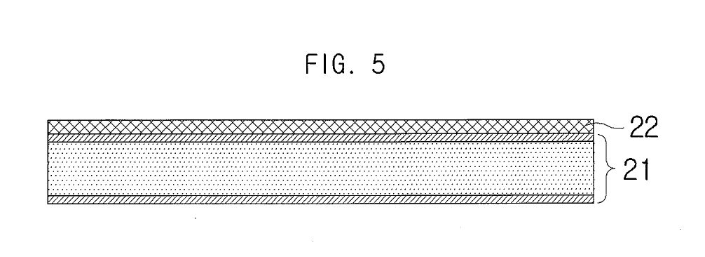

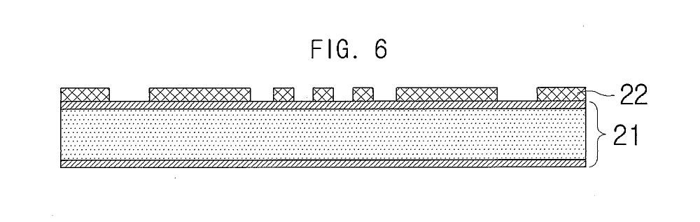

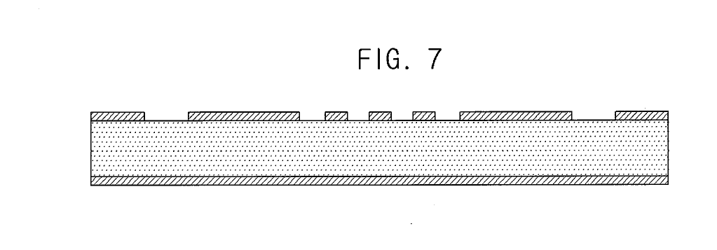

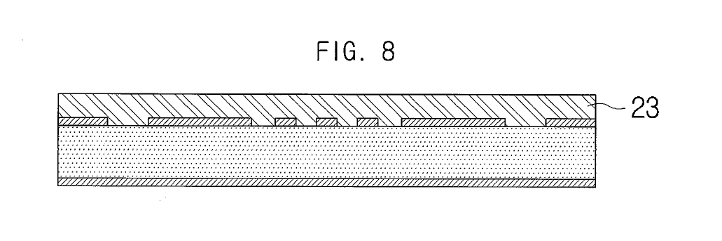

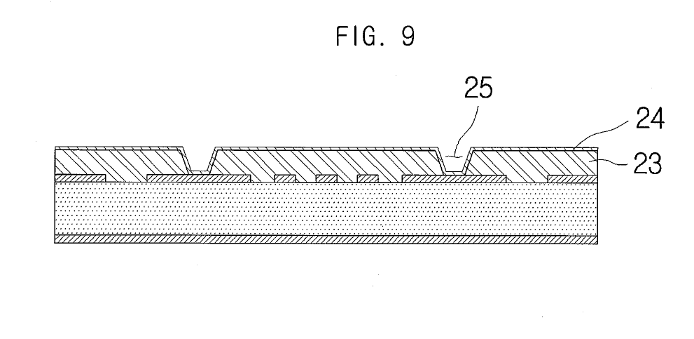

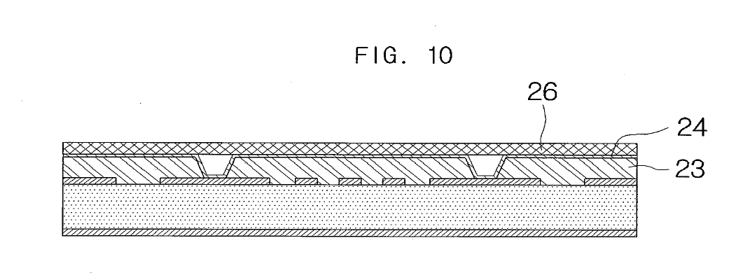

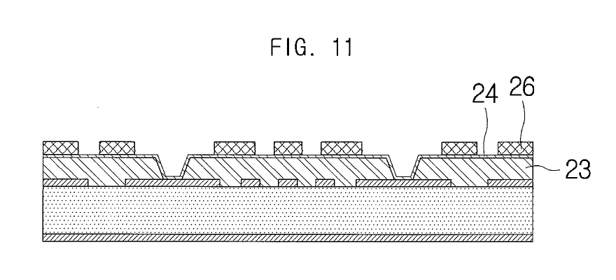

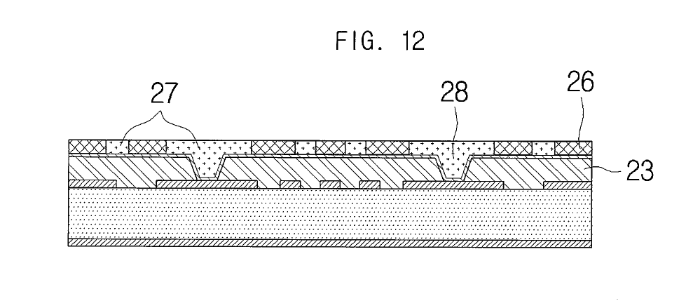

As shown in FIG. 5, an etching resist film 22 is laminated on a copper clad laminate 21 (S10 in FIG. 4). It is then exposed to light and developed (FIG. 6 and S20 in FIG. 4). A circuit pattern is formed (FIG. 7 and S30 in FIG. 4) and an insulating layer 23 is laminated (FIG. 8 and S40 in FIG. 4). Via holes 25 are formed by using a laser and a coating layer 24 is formed by using electroless plating (FIG. 9 and S50 in FIG. 4). An etching resist film 26 is then laminated (FIG. 10 and S60 in FIG. 4) and the etching resist is formed corresponding to the circuit pattern (FIG. 11 and S70 in FIG. 4). A paste 27 including the carbon nanotube of the invention is then filled to the via holes by employing the printing process to form via 28 (FIG. 12 and S80 in FIG. 4).

The conductive paste of the invention may be also applied to multilayer printed circuit boards and further to various boards including pad combined printed circuit boards or landless printed circuit boards.

Hereinafter, although more detailed descriptions will be given by examples, those are only for explanation and there is no intention to limit the invention.

### EXAMPLE

### Examples 1-7 And Comparison Example 1

Multi-walled carbon nanotubes (product of Iljinsa Co., Ltd.) were placed in a solution including nitric acid and sulfuring acid in 1:3 at 120° C. for 10 hours. The carbon nanotubes were washed with distilled water and the metal alloy having a low melting temperature were prepared as shown in Table 2. A hardening agent was added to the conductive paste having a composition in Table 3 and 3 roll mill was used.

The mat surface of an electrolytic copper foil having a thickness of 18 μm was coated with the paste of Examples 1 to 7 and Comparison Example 1 by using the printing method and dried. This process was repeated 5 times to form a bump in a circular corn shape having a diameter of a bottom side of 150 μm and a height of 187 μm. One prepreg B was placed on the bump and penetrated. The mat surface of an electrolytic copper foil having a thickness of 18 μm was then positioned toward the bottom side thereon. A stainless steel plate was placed on the both outside surfaces and laminated under vacuum conditions of 180° C., 20 kgf/cm², 2 mmHg for 90 min to produce both side copper clad laminate.

Circuits were formed on the surface of the copper clad laminate to form daisy chain. Resistances at both ends of the daisy chain by using 4 point probe method were determined. Minimum initial resistance was calculated as dividing the resistance value by the number of bump 24 in the chain (here, the contact resistance was ignored). The result is summarized in Table 3.

TABLE 2

| Example | LMPA |
|---|---|
| 1 | 42Sn/58bi |
| 2 | 42Sn/58bi |
| 3 | 42Sn/58bi |
| 4 | 26Sn/53Bi/21Cd |
| 5 | 70In/30Sn |
| 6 | 50Sn/50Sn |
| 7 | 10In/53Sn/37Bi |

TABLE 3

| | Example | | | | | | | Comparison |
|---|---|---|---|---|---|---|---|---|
| | 1 | 2 | 3 | 4 | 5 | 6 | 7 | Example 1 |
| CNT (wt %) | 85 | 85 | 80 | 85 | 85 | 85 | 85 | 90 |
| LMPA (wt %) | 5 | 10 | 10 | 5 | 5 | 5 | 5 | — |
| Binder (epon-862) | 5 | 5 | 5 | 5 | 5 | 5 | 5 | 10 |
| Pickling agent | 5 | — | 5 | 5 | 5 | 5 | 5 | — |
| (RF800NS) | | | | | | | | |
| Initial resistance (mΩ) | 2 | 5 | 7 | 7 | 7 | 5 | 10 | 20 |

* epon-862 (Shell Chemical Company)
* RF800NS (Alpha metals)

### Reliability Test

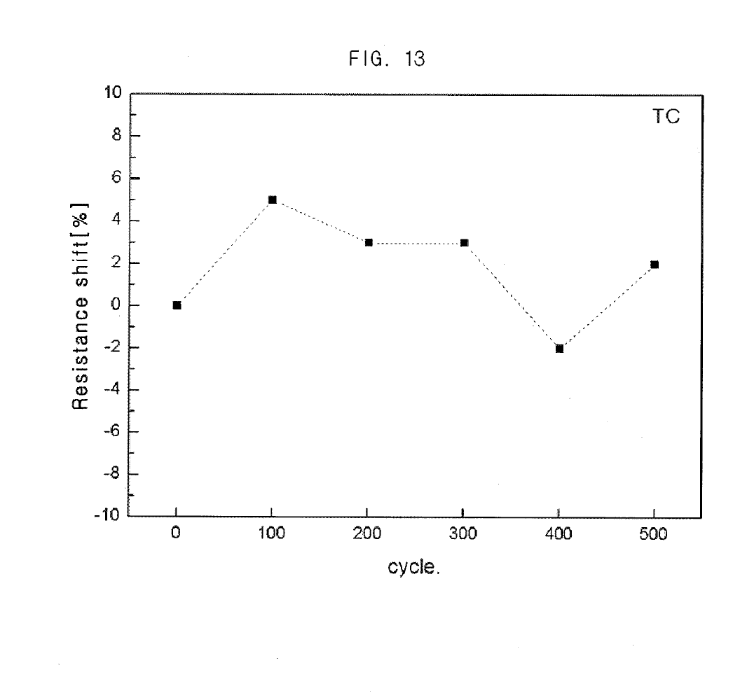

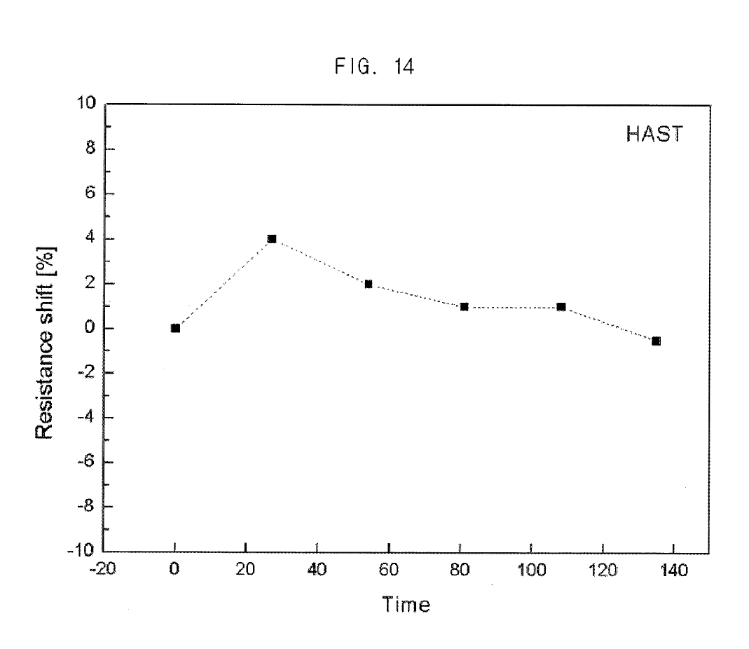

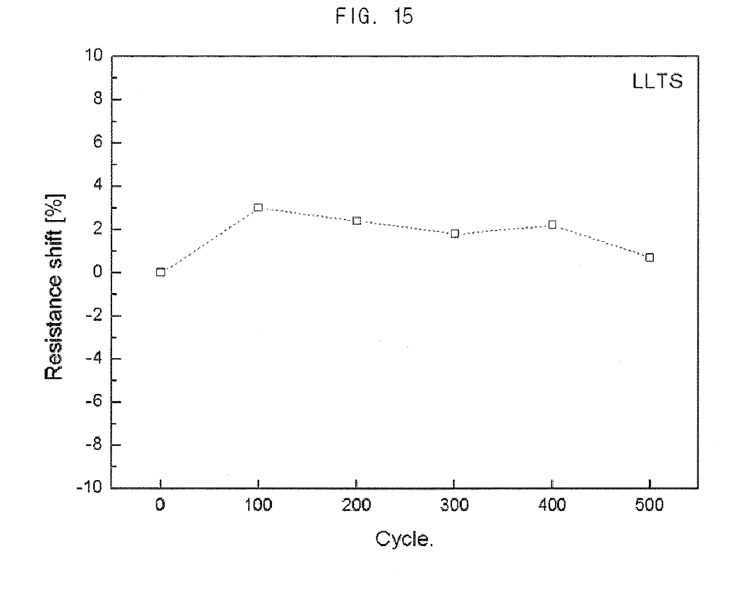

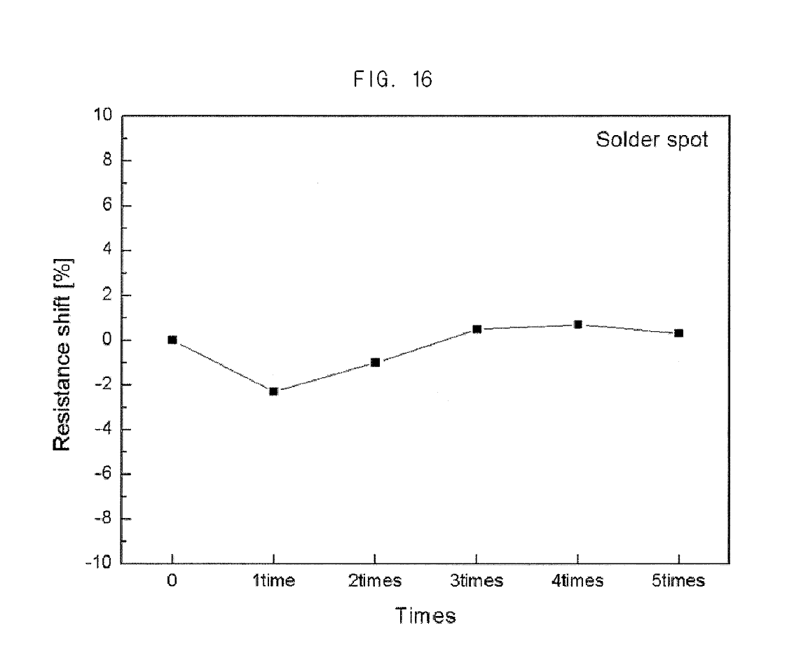

The conductive paste of Example 1 was tested for the reliability against thermal cycle (TC), high accelerated temperature/humidity test (HAST), liquid-liquid thermal shock (LLTS) and solder spot. The result is shown in FIGS. 13 to 16. As shown in FIGS. 13 to 16, it was noted that it satisfied the rate change of <±10% of a resistance against an initial resistance which is a test standard for the reliability.

The reliability test was performed with a typical device for the reliability test.

It is noted from Examples and Comparison Example that the conductive past of the invention has excellent electrical conductivity due to low resistance.

It is to be appreciated that various changes and modifications may be made by those skilled in the art without departing from the spirit and scope of the present invention, as defined by the appended claims and their equivalents.

What is claimed is:

1. A conductive paste comprising a carbon nanotube, a metal alloy having a low melting temperature and a binder.

2. The conductive paste of claim 1, comprising 70-90 wt % of the carbon nanotube, 1-25 wt % of the metal alloy having a low melting temperature and 1-15 wt % of the binder.

3. The conductive paste of claim 1, further comprising metal particles.

4. The conductive paste of claim 3, wherein 1-10 wt % of the metal particles is used.

5. The conductive paste of claim 3, wherein the metal particles is selected from the group consisting of silver, copper, tin, indium, nickel and a mixture thereof.

6. The conductive paste of claim 1, wherein the carbon nanotube is selected from the group consisting of a single walled nanotube, a multi walled nanotube and a mixture thereof.

7. The conductive paste of claim 1, wherein the metal alloy having a low melting temperature is at least two selected from the group consisting of tin, bismuth, indium, sliver and cadmium.

8. The conductive paste of claim 1, wherein the alloy having a low melting temperature is an alloy selected from the group consisting of tin/bismuth, bismuth/tin/cadmium, indium/tin and indium/tin/bismuth.

9. The conductive paste of claim 8, wherein the tin/bismuth alloy has 40-45 wt % of tin and 60-55 wt % of bismuth; the bismuth/tin/cadmium alloy has 45-50 wt % of bismuth, 15-40 wt % of tin, and 15-40 wt % of cadmium; the indium/tin alloy has 50-70 wt % of indium and 50-30 wt % of tin; and the indium/tin/bismuth alloy has 5-30 wt % of indium, 30-60 wt % of tin and 25-45 wt % of bismuth.

10. The conductive paste of claim 1, wherein the binder is selected from the group consisting of a thermosetting resin, a thermoplastic resin, a UV hardening resin, a radical hardening resin and a mixture thereof.

11. The conductive paste of claim 10, wherein the thermosetting resin is selected from the group consisting of an epoxy resin, a cyanate ester resin, a bismaleimide resin, a polyimide resin, a benzocyclobutene resin, a phenol resin and a mixture thereof.

12. The conductive paste of claim 10, wherein the thermoplastic resin is selected from the group consisting of a liquid crystal polyester resin, a polyurethane resin, a polyamidimide resin and a mixture thereof.

13. The conductive paste of claim 1, further comprising an additive selected from the group consisting of a dye, a pigment, a thickening agent, a lubricant, an antifoaming agent, a dispersant, a labeling agent, a brightening agent, a thixotropic agent, a retardant, a pickling agent, an organic filler, an inorganic filler and a mixture thereof.

14. A printed circuit board comprising the conductive paste of claim 1.
